(19) United States
(12) Patent Application Publication
(10) Pub. No.: US 2014/0004472 A1
(43) Pub. Date: Jan. 2, 2014

(54) Candle

(71) Applicant: Haroot Tovanyan, Burbank, CA (US)

(72) Inventor: Haroot Tovanyan, Burbank, CA (US)

(21) Appl. No.: 13/912,026

(22) Filed: Jun. 6, 2013

Related U.S. Application Data
(60) Provisional application No. 61/656,088, filed on Jun. 6, 2012.

(51) Int. Cl. C11C 5/00

(52) U.S. Cl. CPC C11C 5/008
USPC 431/288

(57) ABSTRACT

The present invention is directed, in general, to a candle, including: an inner core, made from a first material with a first melting point; an outer section, made from a second material with a second melting point, the second melting point being greater than the first melting point; and the outer section including one or more portions joined by one or more lines of weakness such that one or more of the portions of the outer section may be removed from the candle.

### RELATED APPLICATIONS

The present invention claims priority to U.S. Provisional Patent Application No. 61/656,088, filed on Jun. 6, 2012, incorporated herein by reference in its entirety.

The present invention is generally directed to a candle comprising an outer layer with a first set of material characteristics and a core with a second set of material characteristics. More specifically, the outer layer comprises stacked wax with a melt temperature higher than the melt temperature of the core.

### BACKGROUND OF THE INVENTION

Candles are well known in the art and have been utilized for hundreds of years as a means to provide light. More recently, candles have undergone a bit of renaissance and are now often used for decoration and style. Additionally, such candles are often imbued with particular scents that are released into the air as the candle burns and the wax melts.

Because candles are not typically used as a primary light source, the length of time a candle burns per use is often much less than in the past. This shortened burn time—or cycle—often results in the center of the candle melting faster, causing the wick and flame to descend, or tunnel, lower into the candle body.

Such descent has at least three (3) drawbacks. First, because the wick and flame are often encircled by wax, the amount of light emitted by the candle may be reduced, as the only direction the light may escape from the candle is directly up. Second, as the wick descends lower into the candle body it may become more difficult to light the candle, particularly with an ordinary match or lighter. Attempting to light such a candle with an ordinary match or lighter may cause harm or injury to the user.

Third, correction or modification of a candle into which a wick has tunneled is difficult, and may result in either the candle being destroyed or the user being injured—for example while trying to cut off the excess candle body.

In addition, even when typical candles are allowed to burn for sufficient time so as to avoid tunneling into the candle body, guttering may occur—which is when the side surface of the candle loses its structural strength and collapses. This often allows the pool of melted wax around the flame to pour out over the table, desk, countertop, etc.

Accordingly, it is desirable to provide a candle which can be easily modified by a user to remove excess candle body through which the wick and flame have tunneled, resulting in a candle that consistently emits light in all directions and is safe and easy to relight. Moreover, it is desirable to provide a candle that when sufficient burn time is provided to prevent tunneling, will not gutter and spill the pool of melted wax from the candle body.

### SUMMARY OF THE INVENTION

In accordance with some embodiments of the present invention, aspects may include a candle, comprising: an inner core, comprising a first material with a first melting point; an outer section, comprising a second material with a second melting point, the second melting point being greater than the first melting point; and the outer section comprising one or more portions joined by one or more lines of weakness such that one or more of the portions of the outer section may be removed from the candle.

In accordance with some embodiments of the present invention, some aspects may include a candle, comprising: an inner core, comprising a first material with a first melting point; at least one wick disposed in the inner core; an outer section, comprising a second material with a second melting point, the second melting point being greater than the first melting point; the outer section comprising one or more portions integrally formed and joined by one or more substantially horizontal lines of weakness such that one or more of the portions of the outer section may be removed from the candle.

In accordance with some embodiments of the present invention, some aspects may include a candle, comprising: an inner core, comprising a first material with a first melting point; at least one wick disposed in the inner core; an outer section, comprising a second material with a second melting point, the second melting point being greater than the first melting point; the outer section comprising one or more portions individually formed and assembled into the outer section, the one or more portions joined by at least one or more horizontal lines of weakness and one or more attachment devices, such that one or more of the portions of the outer section may be removed from the candle.

These and other aspects will become apparent from the following description of the invention taken in conjunction with the following drawings, although variations and modifications may be effected without departing from the spirit and scope of the novel concepts of the invention.

### BRIEF DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 is a plane view of an improved candle design in accordance with some embodiments of the present invention.

FIG. 2 is a plane view of an improved candle design in accordance with some embodiments of the present invention.

FIG. 3 is a plane view of an improved candle design in accordance with some embodiments of the present invention.

FIG. 4 is a plane view of a slice of an outer portion of an improved candle design in accordance with some embodiments of the present invention.

FIG. 5 is a top view of an improved candle design in accordance with some embodiments of the present invention.

FIG. 6 is a plane view of an improved candle design in accordance with some embodiments of the present invention.

FIG. 7 is a plane view of an improved candle design in accordance with some embodiments of the present invention.

FIG. 8 is a plane view of an improved candle design in accordance with some embodiments of the present invention.

FIG. 9 is a plane view of an improved candle design in accordance with some embodiments of the present invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

The present invention is generally directed to a candle comprising an outer layer with a first set of material characteristics and a core with a second set of material characteristics. More specifically, the outer layer comprises stacked wax with a melt temperature higher than the melt temperature of the core.

With reference to FIG. 1, an improved candle assembly 10 in accordance with some embodiments of the present invention will now be discussed. Candle assembly 10 is comprised of an outer portion 20, an inner portion 30, and a wick 40. The inner portion 20 and the outer portion 30 may each have a set of material characteristics different than the other. The material characteristics that differ may include but are not limited to melt temperature, softening temperature, density, etc. In some embodiments, the outer portion 20 may be comprised of a high melting point wax, while the inner portion 30 may be comprised of a lower melting point wax. The inner portion 30 melting point may, for example, be between 121-126 degree Fahrenheit, while the outer portion 20 melting point may have a melting point, for example, between 155-160 degrees Fahrenheit. Accordingly, as the wick lit, the inner portion 20 may create a melt pool comprised of the lower melt temperature wax, while the outer portion 30 may remain sold due to the temperature difference in the melt point between the inner portion 20 and the outer portion 30.

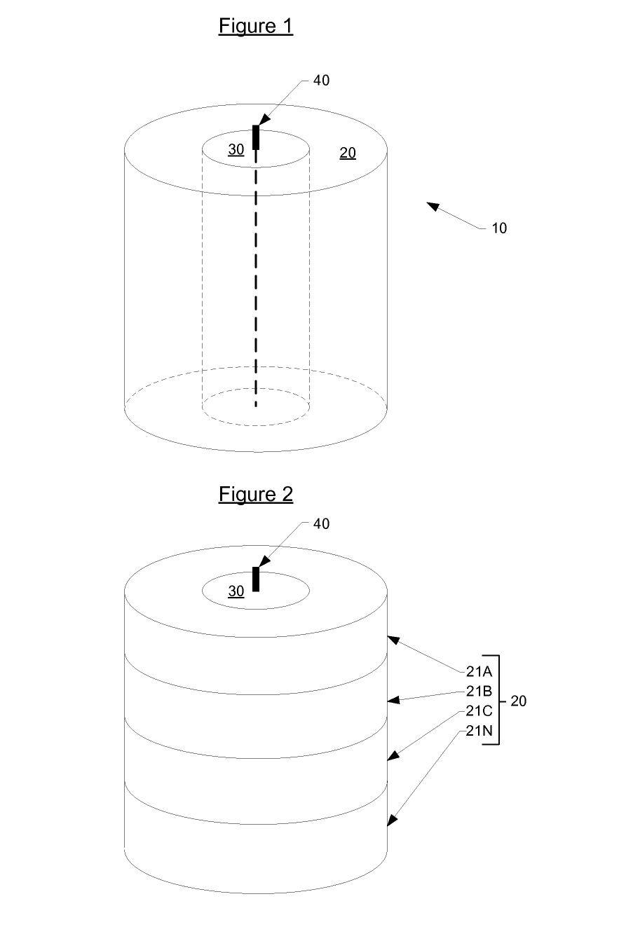

With reference to FIG. 2, a candle assembly 10 will now be discussed. Candle assembly 10 may be comprised an outer portion 20, an inner portion 30, and a wick 40. As discussed above, the inner portion 30 may possess characteristics different than the outer portion 20, for example having a lower melt temperature. Outer portion 20 may comprise a plurality of outer slices 21A-N. Outer slices 21A-N may be stacked on top of each other to form outer portion 20 around inner portion 30. Each outer slice 21A-N may be a pre-sliced, disc-like segment. Such outer slices 21A-N may be pre-fabricated and stacked so that each outer slice 21A-N may be removed from the outer portion 20 as desired.

In operation, the wick 40 may be lit and may cause the inner portion to melt, forming a melt pool around the flame. As the flame burns, the melt pool gradually burns away reducing the size of the inner portion 20. However, because the outer portion 20 may be comprised of a higher melt temperature wax and may not melt as the inner portion 30 does. Once the inner portion 30 has burned below the level of outer slice 21A, outer slice 21A may be removed by a user by twisting or breaking it off of the outer portion 20. As the inner portion 30 continues to burn down, successive outer portions 21B . . . N may be removed.

Construction of candle assembly 10 may be done in any number of manners. For example, the outer portion slices 21 may be pre-made and stacked in alignment, and then wax forming the inner core may be poured into the opening in the outer portion 20. Alternatively, both the inner portion 30 and the outer portion 20 may be pre-made and assembled together.

With reference to FIG. 3, additional characteristics of the present invention may be discussed. As before, candle assembly 10 may be comprised of an outer portion 20, an inner portion 30, and a wick 40. Outer portion 20 may in turn be comprised of outer portion slices 21A-N. Outer portion slices 21A-N may comprise an orifice 23, an opening into which inner portion 30 may be positioned when the candle assembly 10 is assembled.

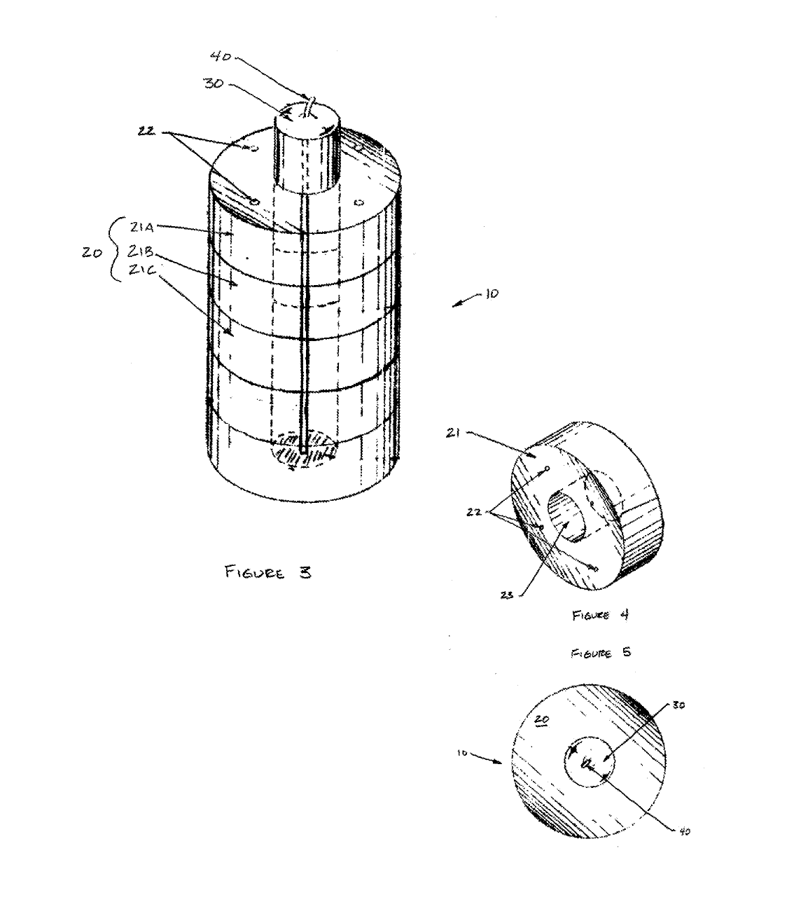

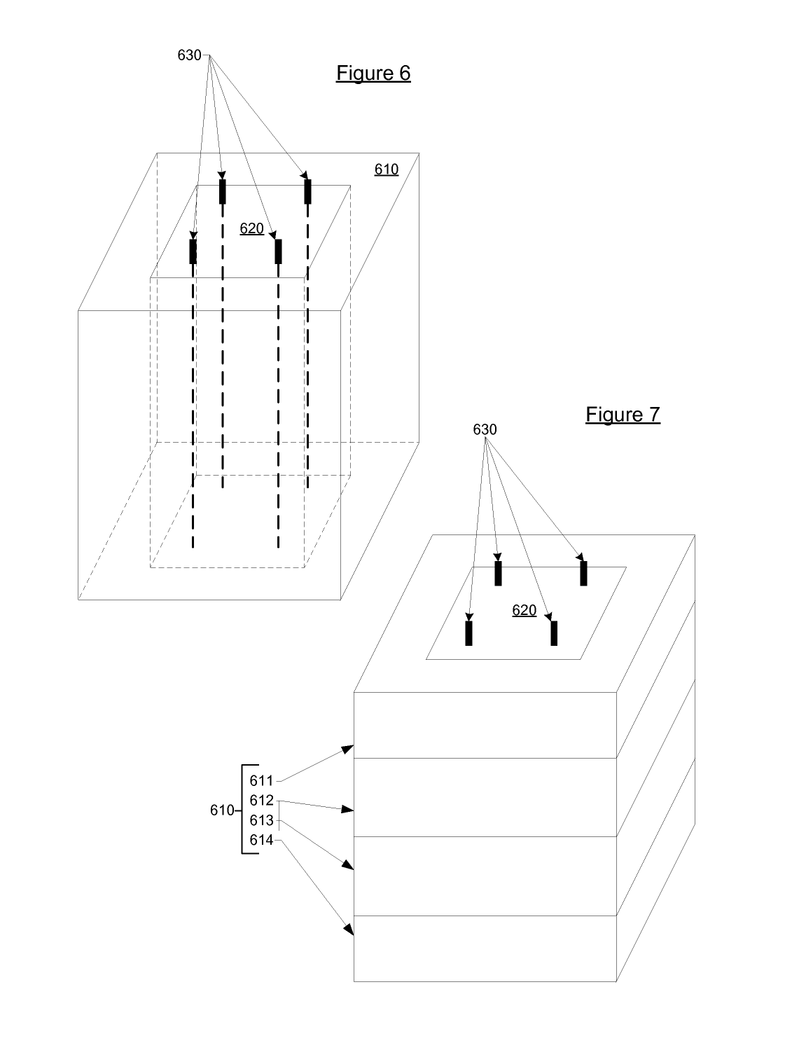

As shown in FIG. 4, outer portion slice 21A-N may additionally comprise attachment devices 22. Attachment devices 22 may comprise any means connecting outer portion slices 21 to each other (e.g., 21A to 21B, 21B to 21C, 21C to 21N, etc.). Attachment devices 22 may comprise any means of attachment, included but not limited to adhesive portions, physical attachment (for example, through spikes or prongs), or even through a partial melt between outer portion slices 21 causing such slices to adhere to each other but not to the extent of becoming integrally formed. Moreover, although FIGS. 3 and 4 depict four (4) evenly spaced attachment devices 22, any number of attachment devices in any arrangement is contemplated.

Note that it is contemplated that the candle assembly 10 may be comprised of various types and forms of wax. For example, the outer portion 30 may comprise wax of a highly compressed fully refined paraffin wax, having an oil content of 0.5% or less. The inner portion 20 may comprise a paraffin wax having an oil content of 1.5-3%. In addition, it is contemplated that the wax may be of various colors and may be embedded with various scents. Moreover, while the figures above illustrate, and the discussion has noted the overall shape of the candle to be cylindrical, the size and shape of the candle 10 may vary significantly. Additionally, the outer portion 20 and the inner portion 30 need not be the same shape. For example, the outer portion 20 may have a square cross section, while the inner portion 30 may have a round cross section. The candle assembly 10, outer portion 20, and inner portion 30 may each be formed in any variety of size or shape. In addition, it is contemplated that a candle assembly 10 may comprise an outer portion 20 and a plurality of inner portions 30—for example in the case of a larger size candle assembly 10. The size of the inner portion 30 and the wick 40 type and size may be selected, designed, and configured so that the heat produced by the burning wick effectively melts the wax comprising the inner portion 30 without overly melting the outer portion 20.

Note that a candle in accordance with some embodiments of the present invention may take any shape or any size. For example, with reference to FIGS. 6 and 7, a candle may have a square or substantially square cross section. As with the candles discussed above, candle 60 may comprise an outer portion 610 of wax that may melt at a higher temperature than an inner core 620. Note that candles in accordance with some embodiments of the present invention may also comprise one or more wicks 630. As seen in FIG. 7, (which sets forth a candle 70 comprising an outer portion of high-temperature melt wax 710, a core of lower-temperature melt wax 620, and one or more wicks 730), the outer portion 710 may be broken into a plurality of sections, 711, 712, 713, 714, separated by one or more lines of weakness or joints 740. Much as discussed above, as the candle burns and the inner core 720 descends into the outer portion 710, pieces of the outer portion may be removed, thereby allowing the candle flame to remain substantially visible throughout the candle use.

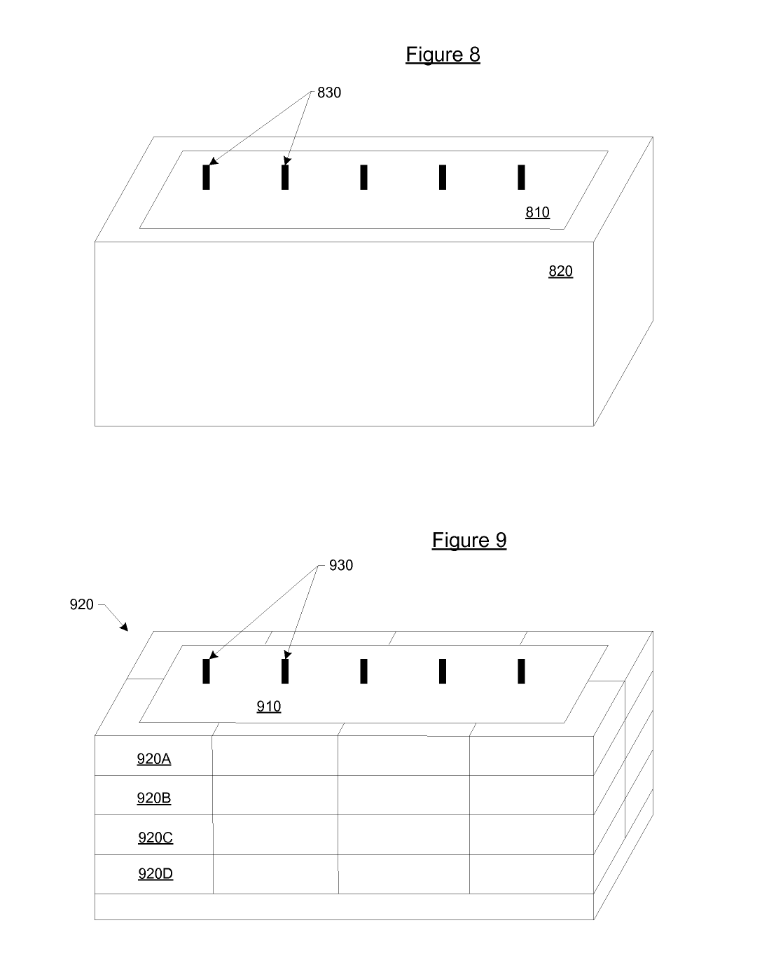

Note that with reference to FIGS. 8 and 9, the candle may comprise additional other shapes, such as but not limited to a rectangular candle 80, 90, with multiple wicks 830, 930. Again, the candle 80, 90 may comprise an inner core 810, 910 of low melt wax, surrounded by an outer portion 820, 920 of higher melt wax. The outer portion 810, 910 may comprise a plurality of sections that may be joined by an attachment device or adhesive, or may formed from an integral piece of material separated by a plurality of lines of weakness. With reference to FIG. 9, it can be seen that the outer portion 920 may be separated into a plurality of portions by both vertical (or substantially vertical) and horizontal (or substantially horizontal) lines of weakness, adhesive, or interfaces.

Having numerous divisions, interfaces lines of weakness, etc. may assist in breaking off portions of the outer section 820. Such divisions, interfaces, lines of weakness, etc. may be required or advantageous when a candle is large, in order to avoid having to break off and/or remove too large of a portion.

It will be understood that the specific embodiments of the present invention shown and described herein are exemplary only. Numerous variations, changes, substitutions and equivalents will now occur to those skilled in the art without departing from the spirit and scope of the invention. Moreover, the particular shape and arrangement of the outer portion 20 and inner portion 30 may vary. Accordingly, it is intended that all subject matter described herein and shown in the accompanying drawings be regarded as illustrative only, and not in a limiting sense.

What is claimed is:

1. A candle, comprising:
an inner core, comprising a first material with a first melting point;
an outer section, comprising a second material with a second melting point, the second melting point being greater than the first melting point;
the outer section comprising one or more portions joined by one or more lines of weakness such that one or more of the portions of the outer section may be removed from the candle.

2. The candle of claim 1, wherein the one or more portions of the outer section may be integrally formed.

3. The candle of claim 1, wherein the one or more portions of the outer section may be individually formed and assembled into the outer section.

4. The candle of claim 3, wherein the candle further comprises one or more attachment devices disposed between at least two of the one or more portions of the outer section.

5. The candle of claim 4, wherein the attachment device comprises an adhesive.

6. The candle of claim 4, wherein the attachment device comprises spikes or prongs.

7. The candle of claim 4, wherein the attachment devices comprises a partial melt between the at least two of the one or more portions of the outer section.

8. The candle of claim 1, further comprising one or more wicks.

9. The candle of claim 1, wherein the one or more lines of weakness are in a substantially horizontal plane.

10. The candle of claim 9, wherein the one or more lines of weakness are also in a substantially vertical plane.

11. The candle of claim 1, wherein the candle has a substantially circularly cross section.

12. The candle of claim 1, wherein the candle has a substantially square cross section.

13. A candle, comprising:
an inner core, comprising a first material with a first melting point;
at least one wick disposed in the inner core;
an outer section, comprising a second material with a second melting point, the second melting point being greater than the first melting point;
the outer section comprising one or more portions integrally formed and joined by one or more substantially horizontal lines of weakness such that one or more of the portions of the outer section may be removed from the candle.

14. A candle, comprising:
an inner core, comprising a first material with a first melting point;
at least one wick disposed in the inner core;
an outer section, comprising a second material with a second melting point, the second melting point being greater than the first melting point;
the outer section comprising one or more portions individually formed and assembled into the outer section, the one or more portions joined by at least one or more horizontal lines of weakness and one or more attachment devices, such that one or more of the portions of the outer section may be removed from the candle.

15. The candle of claim 14, wherein the one or more attachment devices comprise an adhesive.

16. The candle of claim 14, wherein the one or more attachment devices comprise spikes or prongs.

17. The candle of claim 14, wherein the one or more attachment devices comprise a partial melt between the at least two of the one or more portions of the outer section.

18. The candle of claim 14, wherein the one or more lines of weakness are also in a substantially vertical plane.

19. The candle of claim 14, wherein the candle has a substantially circularly cross section.

20. The candle of claim 14, wherein the candle has a substantially quadrilateral cross section.
